(19) United States
(12) Patent Application Publication
(10) Pub. No.: US 2025/0245612 A1
(43) Pub. Date: Jul. 31, 2025

(54) FREIGHT CARRIER ALLOCATION WITH LANE CONSTRAINTS

(71) Applicant: Walmart Apollo, LLC, Bentonville, AR (US)

(72) Inventors: Liqing Zhang, Humble, TX (US); Kunlei Lian, Windermere, FL (US); Rohan Prakash, Centerton, AR (US); Li Ji, Fremont, CA (US); Nadere Mansouri, McKinney, TX (US); Etika Agarwal, Bangalore, IN (US); Ming Ni, Pflugerville, TX (US); Ti Zhang, Rocklin, CA (US); Jing Huang, San Jose, CA (US); Mingang Fu, Palo Alto, CA (US)

(73) Assignee: Walmart Apollo, LLC, Bentonville, AR (US)

(21) Appl. No.: 18/426,115

(22) Filed: Jan. 29, 2024

(51) Int. Cl. G06Q 10/0835; G06Q 10/0834

(52) U.S. Cl. CPC G06Q 10/08355; G06Q 10/08345

(57) ABSTRACT

A method including obtaining information about a batch of loads. The method also can include determining one or more respective alternative assignments that are feasible for each of the loads. The method additionally can include generating an assignment based on selecting a respective selected carrier for each of the loads from among the one or more respective alternative assignments for each of the loads. Generating the assignment can include using respective deviation scores when there are multiple primary carriers among the one or more respective alternative assignments. The method further can include modifying the assignment for a subset of the loads based on a flex rate. The method additionally can include outputting the assignment, as modified. Other embodiments are described.

### TECHNICAL FIELD

This disclosure relates generally to a freight carrier allocation with lane constraints.

### BACKGROUND

Freight carriers generally specify pre-defined routes between origin and destination regions. An origin or destination region can be as big as a state, or as small as a specific facility location. For example, a first type of lane can be from a first facility to a second facility, a second type of lane can be from a first zip code to a second zip code, and third type of lane can be from a first state to a second state. In some cases, there can be multiple respective freight carriers that deliver on each lane.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for freight carrier allocation with lane constraints, according to an embodiment;

FIG. 4 illustrates an exemplary portion of a freight transportation network with loads;

FIG. 5 illustrates lanes for a portion of the freight transportation network of FIG. 4;

FIG. 6 illustrates a flow chart for a method of freight carrier allocation with lane constraints, according to an embodiment;

FIG. 7 illustrates a flow chart for a method of generating alternative loads, according to an embodiment;

FIG. 8 illustrates a flow chart for a method of selecting a carrier for each load, according to an embodiment;

FIG. 9 shows an equation for calculating the deviation score, a table with exemplary data for a load with two primary carriers, an example calculation for the deviation score for a first carrier, and an example calculation for the deviation score for a second carrier;

FIG. 10 shows an equation for calculating a maximum number of flexible loads, and tables of exemplary outputs of a carrier assignment listed by load for two total loads in a batch and listed by lane and carrier; and

FIG. 11 illustrates a flow chart for a method of adding flex to modify the assignment for the subset of the loads, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

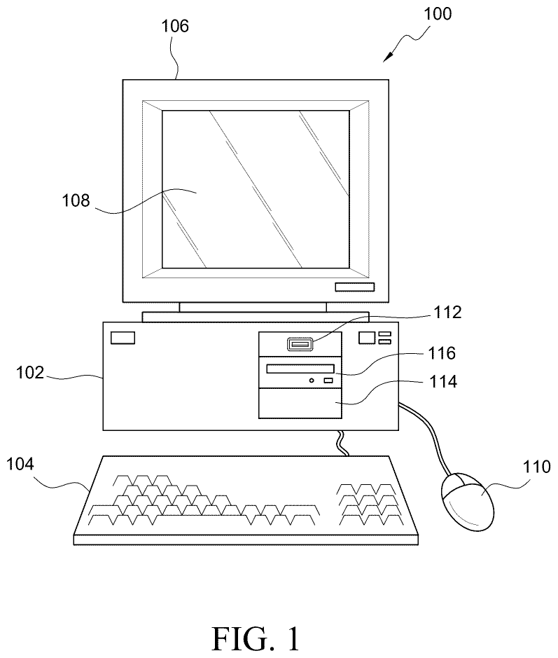

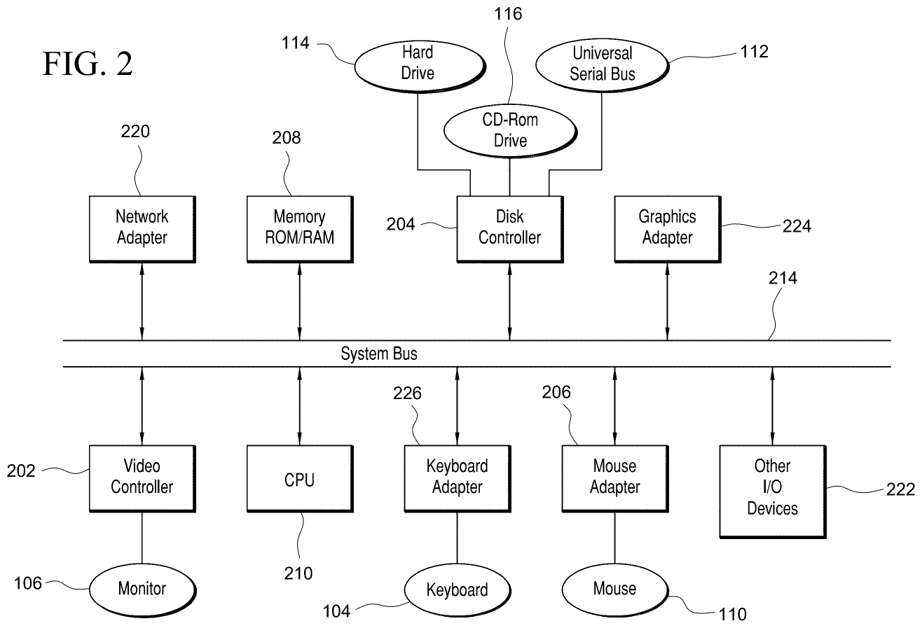

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

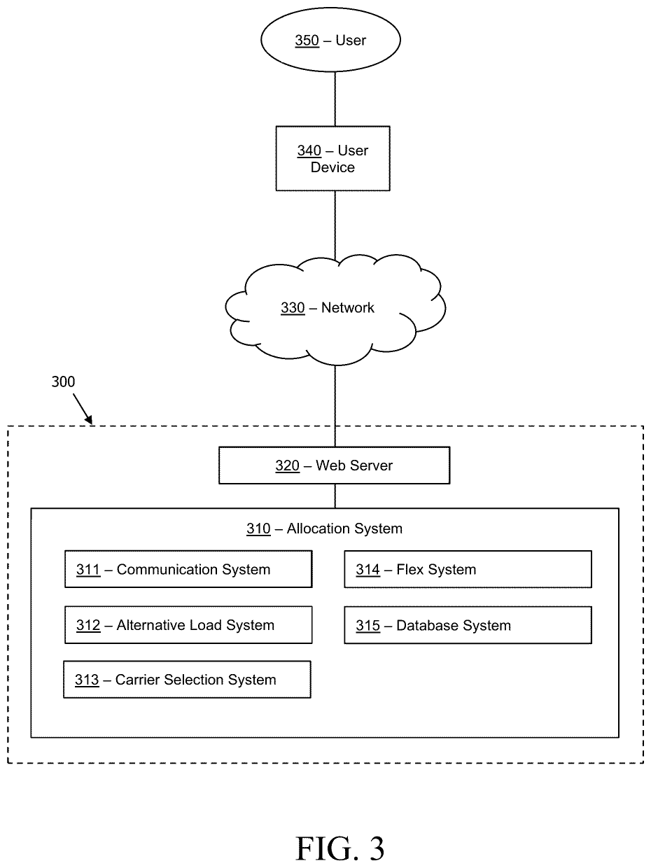

Turning ahead in the drawings, FIG. 3 illustrates a block diagram of a system 300 that can be employed for freight carrier allocation with lane constraints, according to an embodiment. System 300 is merely exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include an allocation system 310 and/or a web server 320. Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Allocation system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host allocation system 310 and/or web server 320. Additional details regarding allocation system 310 and/or web server 320 are described herein.

In some embodiments, web server 320 can be in data communication through a network 330 with one or more user devices, such as a user device 340. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to interface with allocation system 310, such as to allocate freight carriers for a freight transportation network.

In some embodiments, an internal network that is not open to the public can be used for communications between allocation system 310 and web server 320 within system 300. Accordingly, in some embodiments, allocation system 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, or (ii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Android™ operating system developed by the Open Handset Alliance, or (iii) the Windows Mobile™ operating system by Microsoft Corp. of Redmond, Washington, United States of America.

In many embodiments, allocation system 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to allocation system 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of allocation system 310 and/or web server 320. In a similar manner, the processors and/or the non-transitory computer-readable media can be local and/or remote to each other.

Meanwhile, in many embodiments, allocation system 310 and/or web server 320 also can be configured to communicate with one or more databases, such as a database system 315. The one or more databases can store inputs, constraints, data structures, and/or outputs used in processing the allocation of freight carriers, and/or other suitable information, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit, or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, allocation system 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, allocation system 310 can include a communication system 311, an alternative load system 312, a carrier selection system 313, a flex system 314, and/or database system 315. In many embodiments, various systems of allocation system 310 can be modules of computing instructions (e.g., software modules) stored at non-transitory computer readable media that operate on one or more processors. In some embodiments, various systems of allocation system 310 can be implemented in hardware. Allocation system 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host allocation system 310 and/or web server 320. Additional details regarding allocation system 310 and the components thereof are described herein.

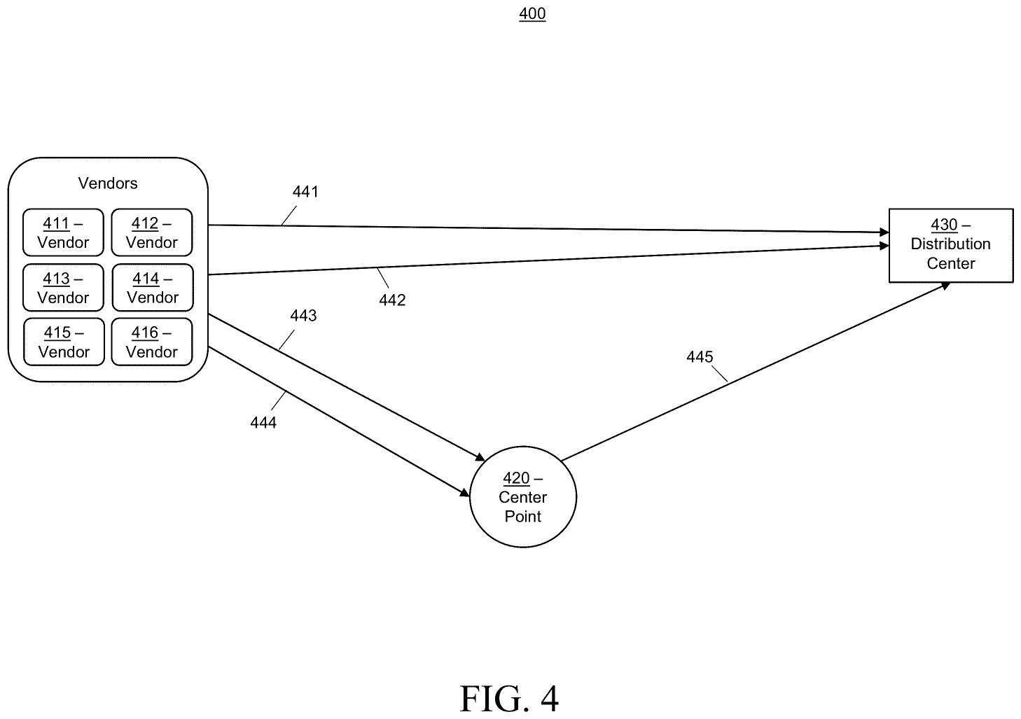

In a number of embodiments, freight carrier allocation can be performed by system 300, allocation system 310, and/or web server 320. Freight carrier allocation can involve allocating carriers for inbound transportation in a freight transportation network, such as allocation of carriers to loads to be transported from vendors to a distribution center. Turning ahead in the drawings, FIG. 4 illustrates an exemplary portion of a freight transportation network 400 with loads 441-445. Freight transportation network 400 can include vendors 411-416, a center point 420, and a distribution center 430. Center point 420 can be a facility that has inbound and outbound docks for receiving and sending items without significant storage of the items. Distribution center 430 can store items and send them to stores, such as when requested by stores.

Loads (also called transportation orders) can be shipped from vendors 411 to distribution center 430 directly, such as in loads 441 and 442 each being shipped from a respective vendor (e.g., 411-416) to distribution center 430, or indirectly through center point 420, such as in loads 443 and 444 each being shipped from a respective vendor (e.g., 411-416) to center point 420, then being shipped via a load 445 from center point 420 to distribution center 430. Loads 441-444 can be referred to as inbound loads, and each load can be assigned a respective carrier, a respective lane, and a respect transport mode. Transport modes can include small package (also referred to as parcel), LTL (less than truck load, meaning not full truck load), TL (truck load, meaning full truck), RL (rail), and/or other suitable modes. Each mode can have associated carriers. For example, small package can be associated with parcel carriers. As an example, as shown in FIG. 4, load 441 can be assigned to a first carrier that transports through the small package mode, load 442 can be assigned a second carrier that transports through the LTL mode, load 443 can be assigned a third carrier that transports through TL, and load 444 can be assigned a fourth carrier that transports through rail.

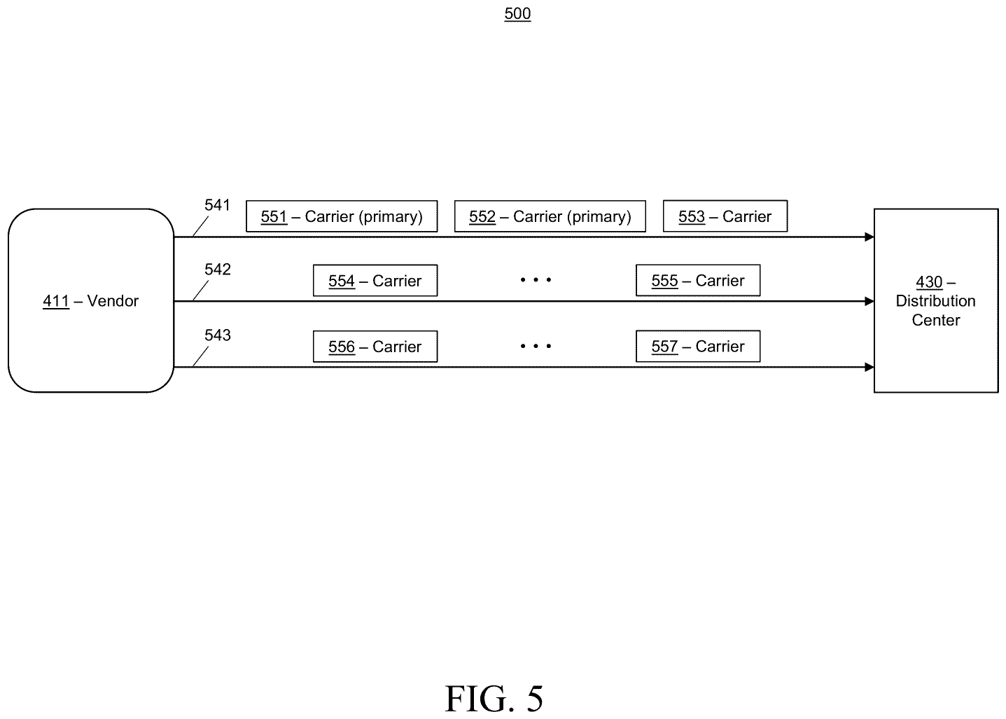

Lanes can be pre-defined routes by carriers between origin and destination regions. Various different lanes can be available for each mode. Various different carriers can be available for each lane. An origin or destination region can be as big as a state, or as small as a specific facility location. Geo-precision can be defined for each lane based on its level of specificity based on its origin and destination regions. Turning ahead in the drawings, FIG. 5 illustrates lanes 541-543 for a portion 500 of freight transportation network 400 (FIG. 4). Inbound network can include vendors 411 and distribution center 430. Lane 541 can have a geo-precision of facility to facility (e.g., the lane is from the facility of vendor 411 to the facility of distribution center 430), and can have three options of carriers, e.g., carriers 551-553. Carriers 551 and 552 can be primary carriers. Primary carriers can be carriers with which the organization has commitments (e.g., contractual commitments) to use the carrier to transport a specified minimum number of loads over a specified time period. For example, there can be a commitment to use carrier 551 to transport 5 loads per week, and there can be a commitment to use carrier 552 to transport 10 loads per week. Carrier 553 can be a secondary carrier (e.g., non-primary carrier). Lane 542 can have a geo-precision of zip code to zip code (e.g., the lane is from the zip code of vendor 411 to the zip code of distribution center 430), and can have two options of carriers, e.g., carriers 554-555. Lane 543 can have a geo-precision of state to state (e.g., the lane is from the state of vendor 411 to the state of distribution center 430), and can have two options of carriers, e.g., carriers 556-557. Lane 541 is the most geo-precise of lanes 541-543, and lane 543 is the lease geo-precise of lanes 541-543.

In many embodiments, lane constraints can be applied when allocating carriers. Lane constraints can be specified by the organization. An example of a lane constraints can be that more-geo-precise lanes are preferred to less geo-precise lanes. Another example of a lane constraint can be that primary carriers are preferred to secondary carriers. Yet another example of a lane constraint can be that co-primary carriers on the same lane should acquire loads regularly and proportionally to their commitments. A further example of a lane constraint can be that a user-defined percentage of loads can use flex for lane constraint, which can assign loads to a cheaper carrier instead of following commitments strictly). In many embodiments, the allocation of carriers, lanes, and transport modes to loads can advantageously be operationally executable, reliable regarding on-time performance, and/or cost-efficient.

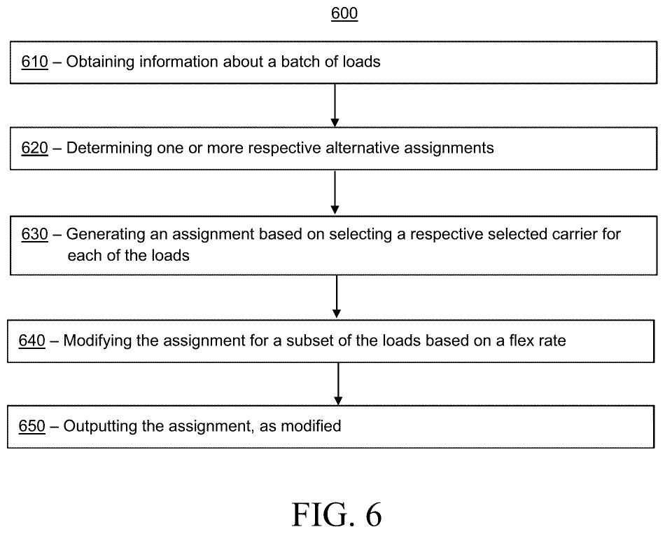

Turning ahead in the drawings, FIG. 6 illustrates a flow chart for a method 600 of freight carrier allocation with lane constraints, according to an embodiment. Method 600 is merely exemplary and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped.

In many embodiments, system 300 (FIG. 3) and/or allocation system 310 (FIG. 3) can be suitable to perform method 600 and/or one or more of the activities of method 600. In these or other embodiments, one or more of the activities of method 600 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

In some embodiments, method 600 and other activities in method 600 can include using a distributed network including distributed memory architecture to perform the associated activity. This distributed architecture can reduce the impact on the network and system resources to reduce congestion in bottlenecks while still allowing data to be accessible from a central location.

Referring to FIG. 6, method 600 can include an activity 610 of obtaining information about a batch of loads. In some embodiments, the information can include a respective initial assignment of a respective initial carrier, a respective initial lane, a respective initial mode for each of the loads, pickup and/or delivery locations and/or windows, and/or other suitable information about the loads. In many embodiments, carrier information also can be obtained. In some embodiments, the carrier information can include information about the applicable equipment (e.g., volume capacity of the equipment, which can be used to determine if it can handle the load), transit time (e.g., duration of transit, such as 5 days), effective dates (expected beginning and/or end dates), and/or other suitable information that can be used for feasibility checking. In various embodiments, the carrier information also can include charges, which can be used for cost calculations. In some embodiments, the carrier information can include commitment information for primary carriers (e.g., weekly minimum commitments), and history usage (e.g., how many loads already done so far this week), which can be used for selection of a primary carrier among co-primary carriers. In a number of embodiments, other inputs can include a flex rate (e.g., a percentage of loads that can deviate from one or more constraints) which can indicate an allowance for cost minimization. In many embodiments, communication system 311 (FIG. 3) can be suitable to perform activity 610.

In a number of embodiments, method 600 also can include an activity 620 of determining one or more respective alternative assignments that are feasible for each of the loads. In many embodiments activity 620 can generate alternative loads, which are candidate loads that are feasible regarding origin-destination pair, equipment capacity, contract effective and/or expiry dates, pickup and/or delivery time windows, and/or other suitable feasibility criteria for each applicable carrier.

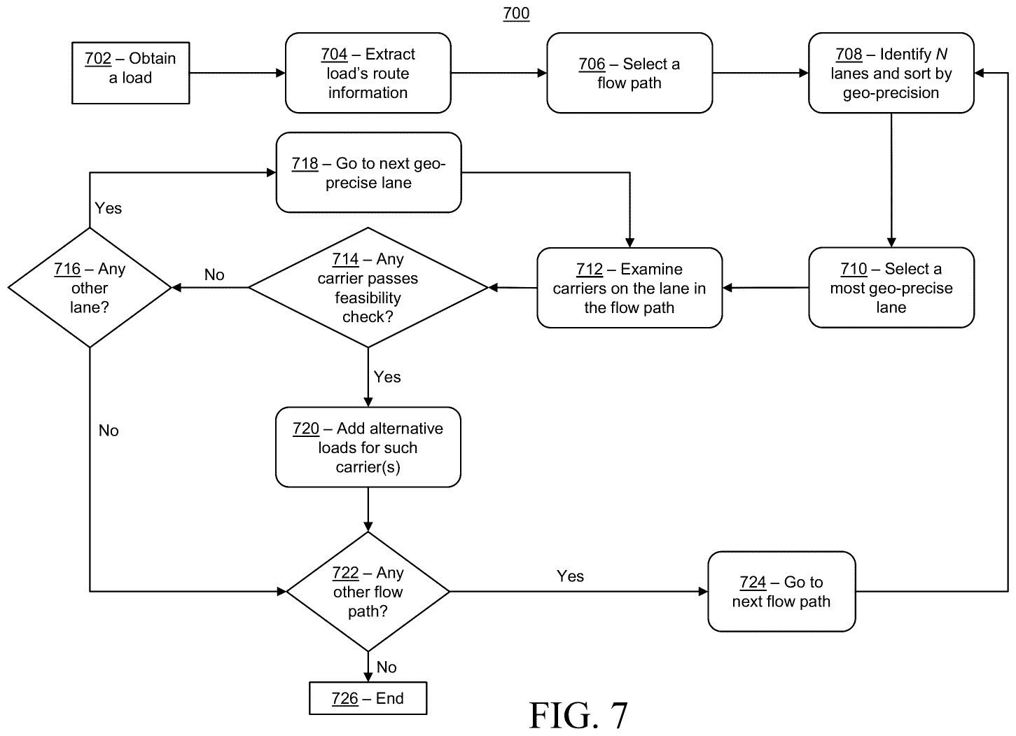

In some embodiments, determining the one or more respective alternative assignments further can include determining one or more respective flow paths for each of the loads based on respective route information for each of the loads; and/or determining one or more respective carriers for each of the one or more respective flow paths based on feasibility and lane geo-precision. In many embodiments, alternative load system 312 (FIG. 3) can be suitable to perform activity 620. In a number of embodiments, activity 620 can be implemented as shown in FIG. 7 and described below.

Turning ahead in the drawings, FIG. 7 illustrates a flow chart for a method 700 of generating alternative loads, according to an embodiment. Method 700 is merely exemplary and is not limited to the embodiments presented herein. Method 700 can be employed in many different embodiments or examples not specifically depicted or described herein. In some embodiments, the procedures, the processes, and/or the activities of method 700 can be performed in the order presented. In other embodiments, the procedures, the processes, and/or the activities of method 700 can be performed in any suitable order. In still other embodiments, one or more of the procedures, the processes, and/or the activities of method 700 can be combined or skipped. In many embodiments, alternative load system 312 (FIG. 3) can be suitable to perform method 700 and/or one or more of the activities of method 700.

Referring to FIG. 7, method 700 can start with an activity 702 of obtaining a load. In many embodiments, each of the loads in the batch can be run through method 700, and in some embodiments, the loads can be ordered by the soonest to the pickup time. Next, method 700 can include an activity 704 of extracting route information for the load, such as the vendor(s), center point, and/or distribution center for the route associated with the load. This route information can be obtained and can be used to determine the flow path(s) for the load. Next, method 700 can include an activity 706 of selecting a flow path. A flow path can be a pattern in which a load is routed. For example, a first type of flow path can be a direct transport from a vendor to a distribution center, a second type of flow path can be a direct transport from vendor to a center point, then a direct transport from the center point to a distribution center, and a third type of flow path can be LTL (which is no necessarily direct, as there can be additional stop(s) at vendors, or others (non-load) for the other portion(s) of the truck load in the LTL.

Next, method 700 can include an activity 708 of identifying N (a configurable parameter) lanes for the flow path (e.g., selected in activity 706) and sorting by geo-precision. For example, N can be set to 3, to select 3 lanes, such as shown in FIG. 5. Next, as shown in FIG. 7, method 700 can include an activity 710 of selecting a most geo-precise lane from among the lanes identified in activity 708. For example, in the example shown in FIG. 5, lane 541 (FIG. 5) can be selected, as facility-to-facility is the most geo-precise of the lane types from among lanes 541-543 (FIG. 5). Next, as shown in FIG. 7, method 700 can include an activity 712 of examining carriers on the lane in the flow path. For example, in the example shown in FIG. 5, there are three carriers (e.g., 551-553 (FIG. 5)) for lane 541 (FIG. 5). These carriers can be tested for feasibility, based on origin-destination pair, equipment capacity, contract effective and/or expiry dates, pickup and/or delivery time windows, and/or other suitable feasibility criteria.

Next, as shown in FIG. 7, method 700 can include an activity 714 of determining whether any of the carrier(s) on the lane in the flow path pass the feasibility check. If the output of activity 714 is no, method 700 next can include an activity 716 of determining whether there are any other lanes identified in activity 708. If the output of activity 714 is yes, method 700 next can include an activity 720, as described above. If the output of activity 716 is yes, method 700 next can include an activity 718 of using the next-most geo-precise lane identified in activity 708, and then returning to activity 712 for examining that lane. If the output of activity 716 is no, method 700 next can include an activity 722, as described below. In activity 720, the carrier(s) that pass the feasibility check can be added to a list of alternative loads, for the alternative assignments for the load. Activity 722 can include determining if there is any other flow path. If the output of activity 722 is yes, method 700 next can include an activity 724 of going to the next flow path, and then returning to activity 708 for that flow path. If the output of activity 722 is no, method 700 can proceed to an end 726. In many embodiments, at the end of method 700, the one or more alternative assignments for the load can include a respective carrier that is feasible and on the lane that is the most geo-precise for each of the flow paths for the load.

Returning to FIG. 6, in several embodiments, method 600 additionally can include an activity 630 of generating an assignment based on selecting a respective selected carrier for each of the loads from among the one or more respective alternative assignments for each of the loads. In many embodiments, generating the assignment can include using respective deviation scores when there are multiple primary carriers among the one or more respective alternative assignments. In a number of embodiments, activity 630 can include selecting a carrier for each load. In various embodiments, the selection of a carrier can consider the flow path, lane hierarchy (based on geo-precision), carrier rank, primary carrier commitment (e.g., weekly commitment), historical usage, charges, and/or other suitable factors.

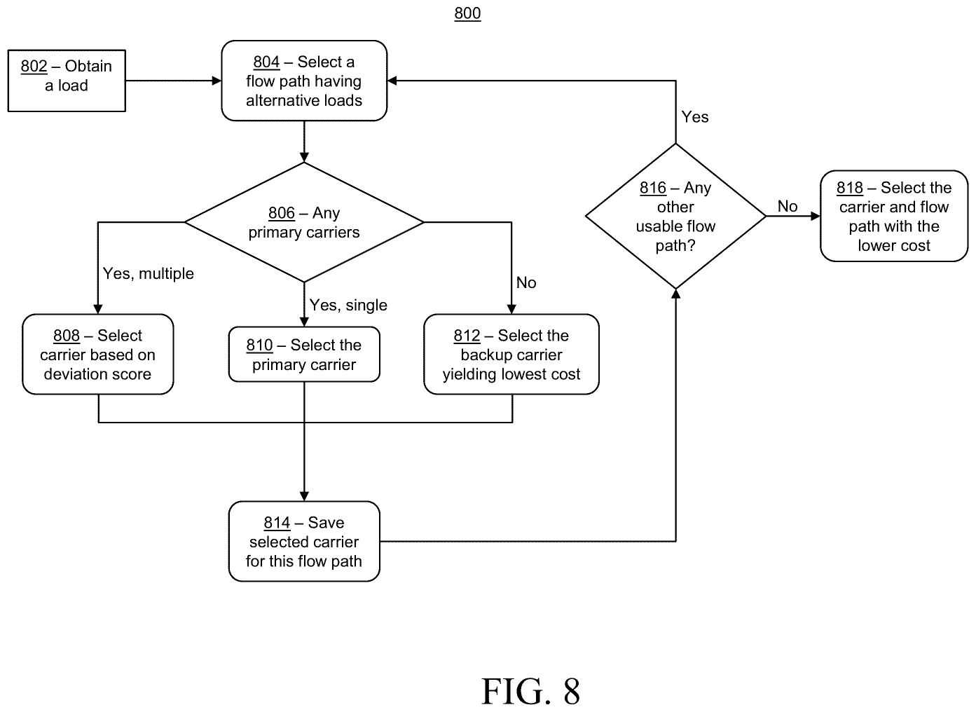

In some embodiments, generating the assignment further can include selecting a respective first carrier for each of the one or more respective flow paths and/or selecting a first flow path from among the one or more respective flow paths. In some embodiments, the respective selected carrier for each or the loads is the respective first carrier for the first flow path. In some embodiments, selecting the respective first carrier for each of the one or more respective flow paths further can include (i) when there are multiple primary carriers among the one or more respective alternative assignments: calculating the respective deviation scores for each of the multiple primary carriers, and selecting the respective first carrier based on the respective deviation scores; (ii) when there is a single primary carrier among the one or more respective alternative assignments, selecting the single primary carrier as the respective first carrier; and (iii) when there is no primary carrier, selecting a backup carrier as the respective first carrier based on an optimization criterion. In many embodiments, the optimization criterion can be minimizing cost. In many embodiments, carrier selection system 313 (FIG. 3) can be suitable to perform activity 630. In a number of embodiments, activity 630 can be implemented as shown in FIG. 8 and described below.

Turning ahead in the drawings, FIG. 8 illustrates a flow chart for a method 800 of selecting a carrier for each load, according to an embodiment. Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of method 800 can be performed in any suitable order. In still other embodiments, one or more of the procedures, the processes, and/or the activities of method 800 can be combined or skipped. In many embodiments, carrier selection system 313 (FIG. 3) can be suitable to perform method 800 and/or one or more of the activities of method 800.

Referring to FIG. 8, method 800 can start with an activity 802 of obtaining a load. In many embodiments, each of the loads in the batch can be run through method 800, and in some embodiments, the loads can be ordered by the soonest to the pickup time, similar as in activity 702 (FIG. 7). Next, method 800 can include an activity 804 of selecting a flow path having alternative loads generated in activity 620 (FIG. 6) and/or method 700 (FIG. 7). Next, method 800 can include an activity 806 of determining if there are any primary carrier, and if so, how many. If the output of activity 806 is yes, and multiple primary carriers, method 800 can proceed to an activity 808 of selecting the carrier based on a deviation score, such as the deviation score as described below. If the output of activity 806 is yes and a single primary carrier, method 800 can proceed to an activity 810 of selecting that single primary carrier as the carrier. If the output of activity 806 is no, then method 800 can proceed to an activity 812 of selecting a backup (secondary) carrier that yields the lowest cost. After activity 808, 810, or 812, as the case may be, method 800 can proceed to an activity 814 of saving the selected carrier (as selected in activity 808, 810, or 812) for this flow path. Next, method 800 can include an activity 816 of determining whether there are any other usable flow paths. If the output of activity 816 is yes, method 800 can return to activity 804 to proceed with that next flow path. If the output of activity 816 is no, method 800 can proceed to an activity 818 of selecting the flow path and associated carrier with the lowest cost.

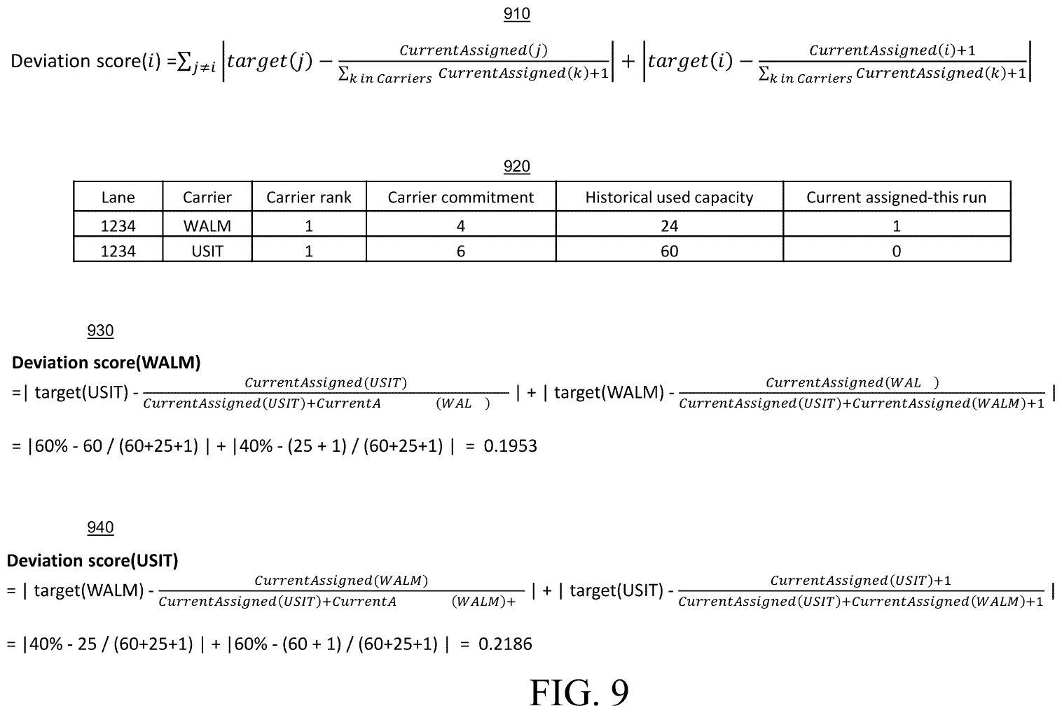

Turning ahead in the drawings, FIG. 9 includes an equation 910 for calculating the deviation score, a table 920 with exemplary data for a load with two primary carriers (labeled WALM and USIT), an example calculation 930 for the deviation score for carrier WALM, and an example calculation 940 for the deviation score for carrier USIT. As shown in FIG. 9, equation 910 can be used to calculate the deviation score for a carrier i, with j representing another carrier among the primary carriers, k representing the primary carrier set, the “target” for a carrier representing a proportion of loads that should be assigned to the carrier based on the proportion of commitments for that carrier, and CurrentAssigned for a carrier representing a sum of the historical used capacity with the load count that is currently assigned to the carrier within this run.

As an example, if examining a load x for a flow path A, Lane 1234 can be the one selected as the most geo-precise and feasible lane for this load in activity 620, and there can be two primary carriers available to choose from, namely a first primary carrier labeled WALM and a second primary carrier labeled USIT. Information about these carriers is shown in table 920. Carrier rank can indicate priority, with 1 being the highest and representing primary carrier, which applies for both of these carriers.

Converting the absolute carrier commitments to percentages representing the portions, target for WALM is calculated as follows:

$$target ( WALM ) = 4 / ( 4 + 6 ) = 40 \% ,$$

and target for USIT is calculated as follows:

$$target ( USIT ) = 6 / ( 4 + 6 ) = 60 \% .$$

Summing the historical used capacity with the load count that is currently assigned to the carrier within this run yields the CurrentAssigned (carrier). For WALM, the Current Assigned can be calculated as follows:

$$CurrentAssigned ( WALM ) = 24 + 1 = 25 ,$$

and for USIT, the Current Assigned can be calculated as follows:

$$CurrentAssigned ( USIT ) = 60 + 0 = 60 .$$

For load x, if the load is assigned to carrier WALM, then the deviation score is 0.1953, as shown in calculation 930. If the load is assigned to carrier USIT, then the deviation score is 0.2186, as shown in calculation 940. In many embodiments, carrier WALM can be selected based on the lower deviation score.

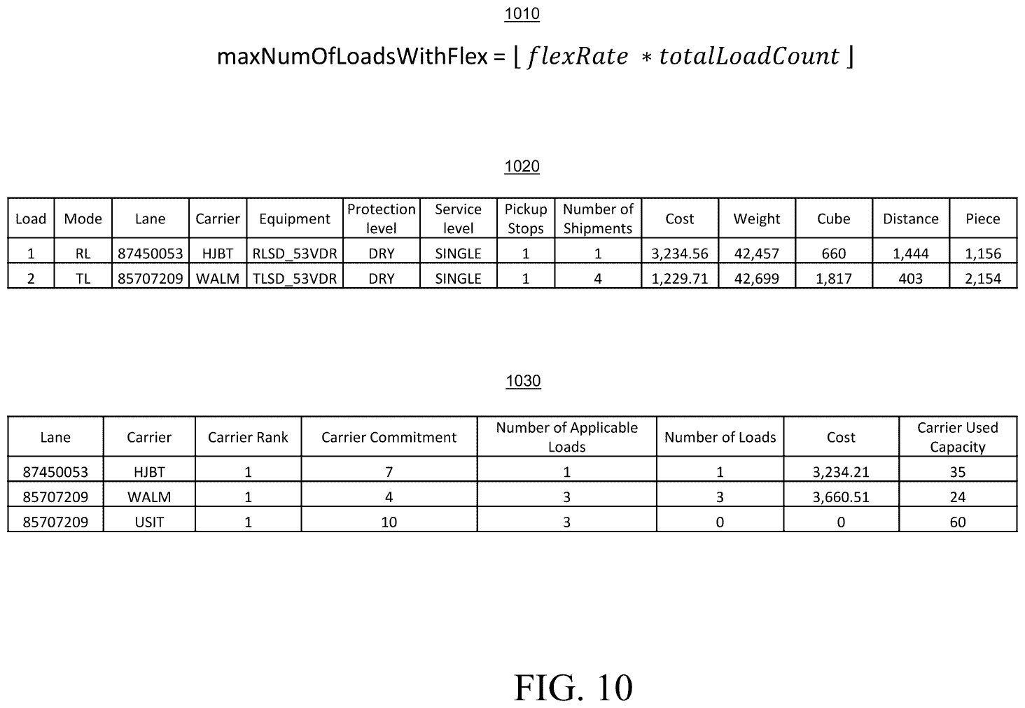

Returning to FIG. 6, in a number of embodiments, method 600 further can include an activity 640 of modifying the assignment for a subset of the loads based on a flex rate. The flex rate can add flexibility to allow for a deviation in some cases from the lane constraints in order to achieve an optimization criterion (e.g., to minimize cost). In a number of embodiments, the flex rate can be a configurable input that is specified, and it can be 2%, 5%, 10%, or another suitable percentage. In some embodiments, activity 640 of modifying the assignment for the subset of the loads based on the flex rate further can include determining a maximum number of flexible loads based on the flex rate and a total number of loads in the batch. For example, the maximum number of flexible loads can be calculated as shown in an equation 1010 of FIG. 10, in which maxNumOfLoadsWithFlex represents the maximum number of flexible loads, the flexRate represents the flex rate, and totalLoadCount represents the total number of loads in the batch, such as 300, 3000, 10,000, or another suitable number of loads.

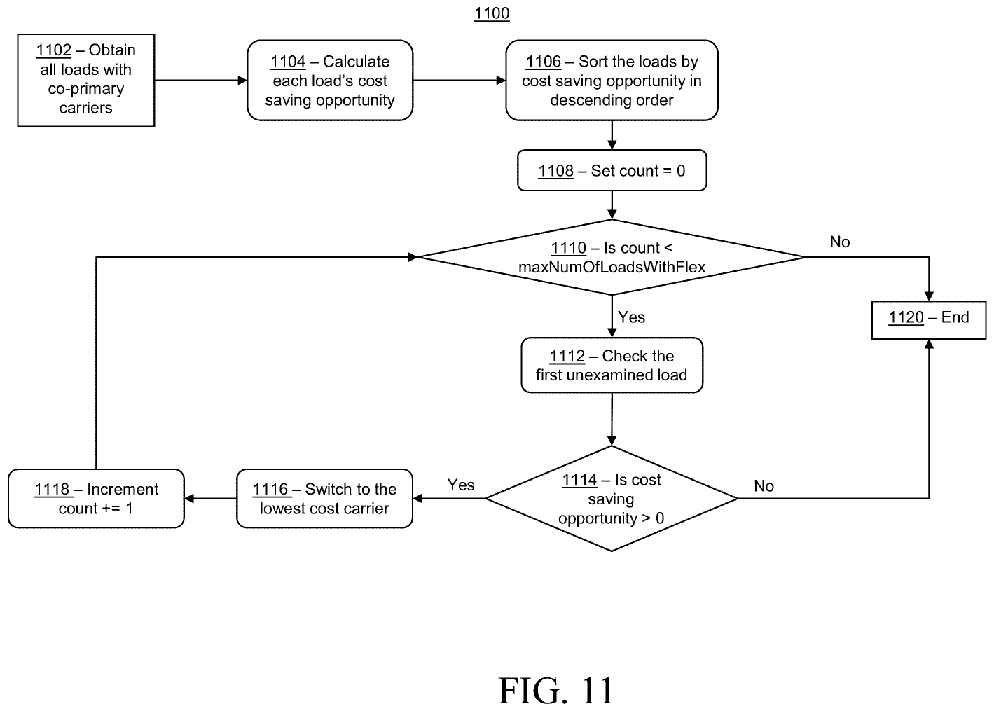

In some embodiments, activity 640 of modifying the assignment for the subset of the loads based on the flex rate further can include selecting a respective alternative carrier for each load of the subset of the loads based on an optimization criterion and replacing the respective selected carrier with the respective alternative carrier. In many embodiments, each load of the subset of the loads is associated with multiple respective primary carriers and/or the respective alternative carrier is selected from among the multiple respective primary carriers. In various embodiments, a quantity of loads of the subset of the loads is limited by the maximum number of flexible loads. In many embodiments, flex system 314 (FIG. 3) can be suitable to perform activity 640. In a number of embodiments, activity 640 can be implemented as shown in FIG. 11 and described below.

Turning ahead in the drawings, FIG. 11 illustrates a flow chart for a method 1100 of adding flex to modify the assignment for the subset of the loads, according to an embodiment. Method 1100 is merely exemplary and is not limited to the embodiments presented herein. Method 1100 can be employed in many different embodiments or examples not specifically depicted or described herein. In some embodiments, the procedures, the processes, and/or the activities of method 1100 can be performed in the order presented. In other embodiments, the procedures, the processes, and/or the activities of method 1100 can be performed in any suitable order. In still other embodiments, one or more of the procedures, the processes, and/or the activities of method 1100 can be combined or skipped. In many embodiments, flex system 314 (FIG. 3) can be suitable to perform method 1100 and/or one or more of the activities of method 1100.

Referring to FIG. 11, method 1100 can start with an activity 1102 of obtaining all loads with co-primary carriers (e.g., loads that were sent through activity 808 (FIG. 8)). Next, method 1100 can include an activity 1104 of calculating or obtaining a cost saving opportunity for each load. For example, if the cost is $500 based on the carrier selected in activity 630 (FIG. 6), and the cost for the cheapest one of the co-primary carriers for the load is $400, then the cost saving opportunity is $100 for that load, as using the deviation score in activity 630 did not result in selecting the most cost-efficient carrier. Next, method 1100 can include an activity 1106 of sorting the loads by cost saving opportunity in descending order (e.g., most cost saving to least cost saving). Next, method 1100 can include an activity 1108 of setting a count to 0. The count can be the number of loads that are altered for flex in this run. Next, method 1100 can include an activity 1110 of determining if the count is less than the maximum number of flexible loads. If the output of activity 1110 is no, method 1100 can proceed to an end 1120. Otherwise, if the output of activity 1110 is yes, method 1100 can include an activity 1112 of checking the first unexamined load in the sorted loads generated in activity 1106. Next, method 1100 can include an activity of determining if the cost saving opportunity for the load is greater than 0. If the output of activity 1114 is not, method 1100 can proceed to end 1120. Otherwise, if the output of activity 1114 is yes, method 1100 can include an activity 1116 of switching from the carrier selected in activity 630 (FIG. 6) and/or method 800 (FIG. 8), and instead using the lowest cost carrier from among the co-primary carriers. Next, method 1100 can include an activity 1118 of incrementing the count. Next, method 1100 can return to activity 1110 with the incremented count.

Returning to FIG. 6, in several embodiments, method 600 additionally can include an activity 650 of outputting the assignment, as modified. In a number of embodiments, outputting the assignment, as modified, can include outputting a respective allocated carrier, a respective allocated lane, and a respective allocated mode for each of the loads. Tables 1020 and 1030 in FIG. 10 show a simplified example of outputs of the assignment. Table 1020 is listed by load for two total loads in a batch. Table 1020 displays, for each load, the transport mode (different for each load in this example), the lane (different for each load in this example), the carrier (based on the carrier label), an equipment code for the equipment, the protection level (e.g., dry, perishable, etc.), the service level, the number of pickup stops, the number of shipments (orders) in the load, the cost of the transport option selected, the weight, the volume (cubic), the distance for the transport, and piece. Table 1030 is listed by lane and carrier for 4 total loads in a batch. Table 1030 displays, for each load, the lane (which is the same for the last two carriers, but different for the first carrier), the carrier, the carrier rank (showing all are primary carriers), the carrier commitment (e.g., minimum 7 loads per week for carrier HJBT), the number of applicable loads (e.g., the number of loads that are feasible for the carrier), the number of loads allocated in the assignment (as modified in activity 640 (FIG. 4)), the cost, and historical data about carrier used capacity.

In many embodiments, the techniques described herein can provide a practical application and several technological improvements. In some embodiments, the techniques described herein can provide for freight carrier allocation that considers carriers' performance while minimizing an objective criterion, which can improve acceptable of carrier allocation and provide controllability on flex allowance. In a number of embodiments, freight carrier allocation can significantly reduce compliance issues for the downstream network. Logic can be extracted from the practices of the organization and transportation carriers. In many embodiments, the techniques can use explicit rules, which can provide users with transparency on the allocation solution. In some embodiments, the techniques can balance cost minimization and carrier performance. In many embodiments, the techniques can convert a cost-driven mathematical result to the reliable and low-risk business decisions with help of empirical science and quantification. In some embodiments, the techniques can bridge between theoretical optimization to transportation business optimization.

In many embodiments, the techniques described herein can run faster, with less processing, than previous approaches (which conventionally generally use mixed integer programming or heuristic-based algorithms). In several embodiments, the techniques can be configurable based on the flow of the process, as described above.

Various embodiments can include a system including one or more processors and one or more non-transitory computer-readable media storing computing instructions that, when executed on the one or more processors, cause the one or more processors to perform certain operations. The operations can include obtaining information about a batch of loads. The operations also can include determining one or more respective alternative assignments that are feasible for each of the loads. The operations additionally can include generating an assignment based on selecting a respective selected carrier for each of the loads from among the one or more respective alternative assignments for each of the loads. Generating the assignment can include using respective deviation scores when there are multiple primary carriers among the one or more respective alternative assignments. The operations further can include modifying the assignment for a subset of the loads based on a flex rate. The operations additionally can include outputting the assignment, as modified.

A number of embodiments can include a computer-implemented method. The method can include obtaining an optimization request at a coordinating engine. The method also can include obtaining information about a batch of loads. The method also can include determining one or more respective alternative assignments that are feasible for each of the loads. The method additionally can include generating an assignment based on selecting a respective selected carrier for each of the loads from among the one or more respective alternative assignments for each of the loads. Generating the assignment can include using respective deviation scores when there are multiple primary carriers among the one or more respective alternative assignments. The method further can include modifying the assignment for a subset of the loads based on a flex rate. The method additionally can include outputting the assignment, as modified.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although freight carrier allocation with lane constraints has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-11 may be modified, and that the foregoing discussion of certain of these embodiments does not necessarily represent a complete description of all possible embodiments. For example, one or more of the procedures, processes, or activities of FIGS. 6-8 and 11 may include different procedures, processes, and/or activities and be performed by many different modules, in many different orders. As another example, the systems and/or engines within system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A computer-implemented method implemented by a processor executing computing instructions, the method comprising:
obtaining information about a batch of loads;
determining one or more respective alternative assignments that are feasible for each of the loads;
generating an assignment based on selecting a respective selected carrier for each of the loads from among the one or more respective alternative assignments for each of the loads, wherein generating the assignment comprises using respective deviation scores for multiple primary carriers among the one or more respective alternative assignments, the respective deviation scores are based on respective proportions of respective commitment targets to each of the multiple primary carriers, and the respective proportions of the respective commitment targets to each of the multiple primary carriers are less than fully met;
modifying the assignment for a subset of the loads based on a flex rate; and
outputting the assignment, as modified.

2. The computer-implemented method of claim 1, wherein determining the one or more respective alternative assignments further comprises:
determining one or more respective flow paths for each of the loads based on respective route information for each of the loads.

3. The computer-implemented method of claim 2, wherein determining the one or more respective alternative assignments further comprises:
determining one or more respective carriers for each of the one or more respective flow paths based on feasibility and lane geo-precision.

4. The computer-implemented method of claim 3, wherein generating the assignment further comprises:
selecting a respective first carrier for each of the one or more respective flow paths; and
selecting a first flow path from among the one or more respective flow paths, wherein the respective selected carrier for each or the loads is the respective first carrier for the first flow path.

5. The computer-implemented method of claim 4, wherein selecting the respective first carrier for each of the one or more respective flow paths further comprises:
for the multiple primary carriers:
calculating the respective deviation scores for each of the multiple primary carriers; and
selecting the respective first carrier based on the respective deviation scores.

6. The computer-implemented method of claim 1, wherein modifying the assignment for the subset of the loads based on the flex rate further comprises:
determining a maximum number of flexible loads based on the flex rate and a total number of loads in the batch.

7. The computer-implemented method of claim 6, wherein modifying the assignment for the subset of the loads based on the flex rate further comprises:
selecting a respective alternative carrier for each load of the subset of the loads based on an optimization criterion; and
replacing the respective selected carrier with the respective alternative carrier.

8. The computer-implemented method of claim 7, wherein:
each load of the subset of the loads is associated with a respective one of the multiple primary carriers; and
the respective alternative carrier is selected from among the multiple primary carriers.

9. The computer-implemented method of claim 6, wherein a quantity of loads of the subset of the loads is limited by the maximum number of flexible loads.

10. The computer-implemented method of claim 1, wherein outputting the assignment, as modified, comprises:
outputting a respective allocated carrier, a respective allocated lane, and a respective allocated mode for each of the loads.

11. A system comprising a processor and a non-transitory computer-readable medium storing computing instructions that, when executed on the processor, cause the processor to perform operations comprising:
obtaining information about a batch of loads;
determining one or more respective alternative assignments that are feasible for each of the loads;
generating an assignment based on selecting a respective selected carrier for each of the loads from among the one or more respective alternative assignments for each of the loads, wherein generating the assignment comprises using respective deviation scores for multiple primary carriers among the one or more respective alternative assignments, the respective deviation scores are based on respective proportions of respective commitment targets to each of the multiple primary carriers, and the respective proportions of the respective commitment targets to each of the multiple primary carriers are less than fully met;
modifying the assignment for a subset of the loads based on a flex rate; and
outputting the assignment, as modified.

12. The system of claim 11, wherein determining the one or more respective alternative assignments further comprises:
determining one or more respective flow paths for each of the loads based on respective route information for each of the loads; and
determining one or more respective carriers for each of the one or more respective flow paths based on feasibility and lane geo-precision.

13. (canceled)

14. The system of claim 12, wherein generating the assignment further comprises:
selecting a respective first carrier for each of the one or more respective flow paths; and
selecting a first flow path from among the one or more respective flow paths, wherein the respective selected carrier for each or the loads is the respective first carrier for the first flow path.

15. The system of claim 14, wherein selecting the respective first carrier for each of the one or more respective flow paths further comprises:
for the multiple primary carriers:
calculating the respective deviation scores for each of the multiple primary carriers; and
selecting the respective first carrier based on the respective deviation scores.

16. The system of claim 11, wherein modifying the assignment for the subset of the loads based on the flex rate further comprises:
determining a maximum number of flexible loads based on the flex rate and a total number of loads in the batch;
selecting a respective alternative carrier for each load of the subset of the loads based on an optimization criterion; and
replacing the respective selected carrier with the respective alternative carrier,
wherein:
each load of the subset of the loads is associated with a respective one of the multiple primary carriers; and
the respective alternative carrier is selected from among the multiple primary carriers.

17-20. (canceled)

21. A non-transitory computer-readable medium storing computing instructions that, when executed on a processor, cause the processor to perform operations comprising:
obtaining information about a batch of loads;
determining one or more respective alternative assignments that are feasible for each of the loads;
generating an assignment based on selecting a respective selected carrier for each of the loads from among the one or more respective alternative assignments for each of the loads, wherein generating the assignment comprises using respective deviation scores for multiple primary carriers among the one or more respective alternative assignments, the respective deviation scores are based on respective proportions of respective commitment targets to each of the multiple primary carriers, and the respective proportions of the respective commitment targets to each of the multiple primary carriers are less than fully met;
modifying the assignment for a subset of the loads based on a flex rate; and
outputting the assignment, as modified.

22. The non-transitory computer-readable medium of claim 21, wherein determining the one or more respective alternative assignments further comprises:
determining one or more respective flow paths for each of the loads based on respective route information for each of the loads; and
determining one or more respective carriers for each of the one or more respective flow paths based on feasibility and lane geo-precision.

23. The non-transitory computer-readable medium of claim 22, wherein generating the assignment further comprises:
selecting a respective first carrier for each of the one or more respective flow paths; and
selecting a first flow path from among the one or more respective flow paths, wherein the respective selected carrier for each or the loads is the respective first carrier for the first flow path.

24. The non-transitory computer-readable medium of claim 23, wherein selecting the respective first carrier for each of the one or more respective flow paths further comprises:
for the multiple primary carriers:
calculating the respective deviation scores for each of the multiple primary carriers; and
selecting the respective first carrier based on the respective deviation scores.

25. The non-transitory computer-readable medium of claim 21, wherein modifying the assignment for the subset of the loads based on the flex rate further comprises:
determining a maximum number of flexible loads based on the flex rate and a total number of loads in the batch;
selecting a respective alternative carrier for each load of the subset of the loads based on an optimization criterion; and
replacing the respective selected carrier with the respective alternative carrier,
wherein:
each load of the subset of the loads is associated with a respective one of the multiple primary carriers; and
the respective alternative carrier is selected from among the multiple primary carriers.
